(19) United States
(12) Patent Application Publication
(10) Pub. No.: US 2002/0097858 A1
(43) Pub. Date: Jul. 25, 2002

(54) Method and apparatus for mobile monitoring of an interactive service center

(76) Inventors: Erich Drobek, Unterhaching (DE); Alexander Schliwa, Unterschleissheim (DE)

Correspondence Address: BELL, BOYD & LLOYD, LLC, P. O. BOX 1135, CHICAGO, IL, 60690-1135, US

(21) Appl. No.: 09/998,074

(22) Filed: Nov. 29, 2001

(30) Foreign Application Priority Data
Nov. 29, 2000 (DE) 100 59 326.7

(51) Int. Cl. H04M 3/00; H04M 5/00

(52) U.S. Cl. 379/265.03

(57) ABSTRACT

A method and apparatus for mobile monitoring of an interactive service center (contact center), having a central installation and a multiplicity of terminals for agents processing inquiries, the monitoring being effected by a supervisor using a mobile communication unit.

### BACKGROUND OF THE INVENTION

Interactive service centers (contact centers) allow high quality of content for the service at optimum cost. In this context, besides the pure service, factors such as waiting time are crucial to a customer for the subjective quality of the contact center. The term interactive service center is used as a generic term covering, by way of example, pure telephone service centers (call centers), with contact centers interacting with customers in various ways; for example, by email, SMS, telephone or over the Internet.

A number of influences increase the complexity of managing the contact center to the extent that the contact center needs to be monitored by a supervisor. By way of example, the number of inquiries or the number of agents processing the inquiries in the contact center varies unpredictably over time. In addition, the agents are split into groups and additionally into various service levels.

As FIG. 2 shows, in a conventional contact center 11, inquiries from the network 8 are forwarded by a central installation 1 to terminals 3-6 for the agents performing the processing. The installation 1 manages all incoming inquiries, records the duration and properties of individual inquiries and makes statistical evaluations of the waiting time or disconnection rate, for example. The contact center 11 is monitored, and possibly controlled, by a supervisor on a monitoring unit 2 which displays the recorded or evaluated data from the contact center 11.

If the contact center 11 and its management have already been optimized, then the supervisor does not need to monitor it constantly. He/she can use some of his/her working time for other tasks, but needs to check the current state in the contact center 11 on the monitoring unit 2 at regular intervals.

It is an object of the present invention, therefore, to devise a method and an arrangement in a contact center such that a supervisor can be employed for other tasks independently of his/her monitoring and control tasks.

### SUMMARY OF THE INVENTION

On the basis of the present invention, in an interactive service center (contact center) in which, under the management of a central installation, at least one person (agent) processes inquiries, data relating to the processing or the management of the processing are recorded, the recorded data are displayed on a mobile communication unit, and the displayed data are monitored by a supervisor. According to the present invention, an apparatus in a contact center includes at least one terminal for an agent processing inquiries, a central installation which manages the processing of the inquiries, a mobile communication unit which displays management data, processing data or data derived therefrom for the supervisor to monitor, and a unit which transmits data for the mobile communication unit. As a result of the inventive method or the inventive apparatus, the supervisor is no longer tied to one particular workplace.

In accordance with one preferred embodiment of the method, the recorded data are used to create supervisory information which is displayed on the mobile communication unit. The reduction in the information to be monitored facilitates monitoring for the supervisor.

In accordance with another preferred embodiment of the method, the supervisory information is transmitted to the mobile communication unit, which reduces the volume of information to be transmitted and avoids creation in the mobile communication unit.

Preferably, the processing or the management of the processing is controlled by the supervisor using the mobile communication unit. As such, when necessary, the supervisor is able to intervene in the procedures in the contact center from any location.

In accordance with another preferred embodiment of the method, the supervisory information is transmitted to the mobile communication unit when an appropriate criterion is satisfied. The correct choice of criterion allows a critical state to be transmitted to the supervisor in such good time that the supervisor is able to take countermeasures in good time before the potential consequences.

It is particularly expedient for the recorded data or the supervisory information to be additionally displayed to the supervisor by a fixed unit, since the mobile communication unit then need not be a full technical replacement for the fixed unit. This allows the supervisory information in the mobile communication unit to be reduced to a necessary degree without limiting the monitoring and control options.

Additional features and advantages of the present invention are described in, and will be apparent from, the following Detailed Description of the Invention and the Figures.

### BRIEF DESCRIPTION OF THE FIGURES

FIG. 1 shows a schematic illustration of an apparatus in accordance with the teachings of the present invention.

FIG. 2 shows a schematic illustration of a conventional interactive service center.

### DETAILED DESCRIPTION OF THE INVENTION

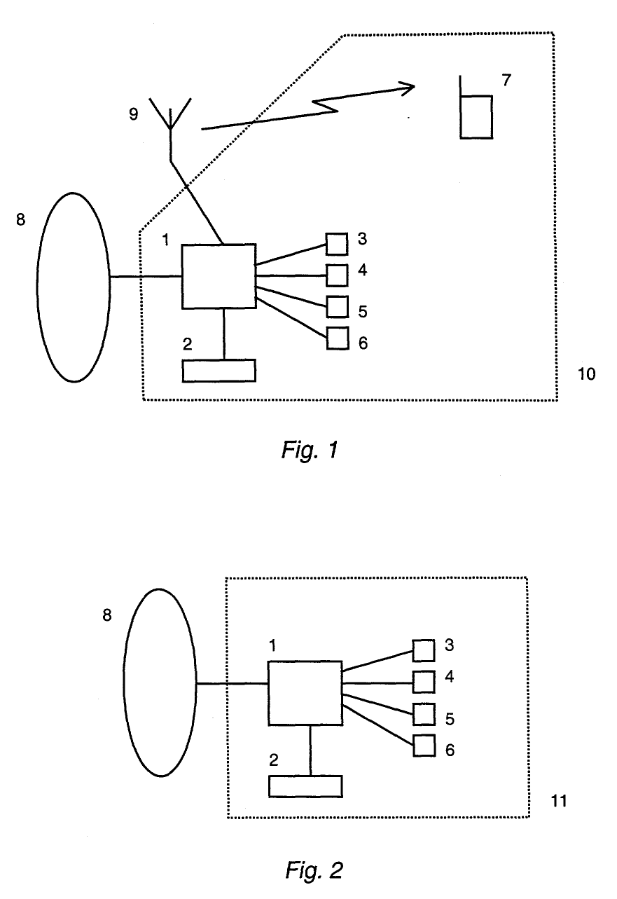

FIG. 1 shows an interactive service center (contact center) 10 having a central installation 1, a fixed monitoring unit 2, terminals 3-6 and a mobile monitoring unit 7. The central installation 1 is connected to the network 8 and to the transmission unit 9. The contact center 10 receives an inquiry from the network 8, and this inquiry is switched in the central installation 1 to the terminal 3-6 of a free agent. The inquiry is then processed by the agent. The agents and their terminals 3-6 may be split into groups and additionally into service levels according to the type or quality of the service.

The central installation 1 records all the data in the contact center 10 which relate to the processing of the inquiries or to management of the processing, and evaluates these data to produce supervisory information. The supervisory information is displayed for a supervisor on the fixed monitoring unit 2. The supervisory information is also transmitted wirelessly, using the transmission unit 9, to a mobile communication unit 7 for the supervisor, which mobile communication unit likewise displays this information. In this context, the transmission unit 9 may be a local mobile telephone system or an interface to the public mobile radio network, for example.

On the basis of the supervisory information displayed, the supervisor can use the mobile communication unit 7 to take control action in the contact center. By way of example, he/she can react to an increased number of inquiries for a group by sending a message to an agent or to the appropriate head of the group to transfer one agent from one group to another for a short time, or by telling the agents in a group to process the inquiries as quickly as possible.

The mobile communication unit 7 also provides the supervisor with the opportunity to follow individual inquiries as they are handled; for example, to monitor calls, to follow processing, to exchange messages with the agents or groups, to remove individual agents from a group or to request additional agents.

Recorded data or the supervisory information can be transmitted to the mobile communication unit 7 at the supervisor's request at regular intervals of time or when critical values for the supervisory information or recorded data (criteria) are reached, or else may be just signaled for the last two methods. These embodiments also can be used in combination with one another.

The supervisory information is created universally in the central installation 1 or in the fixed monitoring unit 2. However, when needed, the supervisor also creates the supervisory information on his/her mobile communication unit 7 and can thus react flexibly to unforeseeable situations.

The supervisory information may be the following, for example: number of inquiries in a queue, inquiry disconnection rate, average disconnection rate, average waiting time, number of inquiries exceeding time, oldest inquiry, overview of agent status (free, processing, finishing off, break, etc.), agent overview, short-term statistics, discrepancies from normal values.

A conceivable mobile communication unit 7 is any mobile computer-controlled unit with a display facility; for example, a pager, a mobile telephone, a personal digital assistant or a portable computer. On the basis of one refinement of the mobile communication unit 7, the recorded data and the supervisory information are transmitted as pure data, voice information, text information or image information. For a mobile telephone, transmission by short message (SMS) or retrieval using WAP is possible, for example.

The inquiries to be processed may be received, by way of example, over the Internet, a public telephone network or a mobile radio network. Considering IP-based telephony, the central installation 1 can be split, by way of example, into a switching unit, an evaluation unit, a CTI server, a local area network, computers for the agents, a local mobile telephone network and a customer database.

Although the present invention has been described with reference to specific embodiments, those of skill in the art will recognize that changes may be made thereto without departing from the spirit and scope of the invention as set forth in the hereafter appended claims.

1. A method for mobile monitoring of an interactive service center where, under management of a central installation, at least one agent processes inquiries, the method comprising the steps of:
recording data relating to at least one of the processing of the inquiries and the management of the processing;
displaying the recorded data, including displaying the data to a supervisor by a mobile communication unit; and
monitoring the displayed data by the supervisor.

2. A method for mobile monitoring of an interactive service center as claimed in claim 1, the method further comprising the step of using the recorded data to create supervisory information which is displayed in the mobile communication unit.

3. A method for mobile monitoring of an interactive service center as claimed in claim 2, the method further comprising the step of transmitting the supervisory information to the mobile communication unit.

4. A method for mobile monitoring of an interactive service center as claimed in claim 2, the method further comprising the steps of:
transmitting at least a selection of the recorded data to the mobile communication unit; and
creating the supervisory information in the mobile communication unit.

5. A method for mobile monitoring of an interactive service center as claimed in claim 1, the method further comprising the step of controlling, by the supervisor using the mobile communication unit, at least one of the processing of the inquiries and the management of the processing.

6. A method for mobile monitoring of an interactive service center as claimed in claim 3, wherein the transmission to the mobile communication unit is wireless.

7. A method for mobile monitoring of an interactive service center as claimed in claim 2, the method further comprising the step of displaying, additionally, at least one of the recorded data and the supervisory information to the supervisor by a fixed unit.

8. A method for mobile monitoring of an interactive service center as claimed in claim 2, wherein the supervisory information is a number of agents available in the contact center.

9. A method for mobile monitoring of an interactive service center as claimed in claim 3, wherein the transmission to the mobile communication unit is effected upon request.

10. A method for mobile monitoring of an interactive service center as claimed in claim 3, wherein the transmission to the mobile communication unit is effected if at least one of the recorded data and the supervisory information satisfies an appropriate criterion.

11. An apparatus in an interactive service center, comprising:
at least one terminal for processing inquiries via an agent;
a central installation for managing the processing of the inquiries;
a mobile communication monitoring unit for displaying at least one of management data, processing data and data derived therefrom for a supervisor; and
a unit for transmitting data for the mobile communication unit.
